(19) United States
(12) Patent Application Publication
(10) Pub. No.: US 2022/0148297 A1
(43) Pub. Date: May 12, 2022

(54) IMAGE FUSION METHOD BASED ON FOURIER SPECTRUM EXTRACTION

(71) Applicant: MOONLIGHT (NANJING) INSTRUMENT CO., LTD., Jiangsu (CN)

(72) Inventors: Xinyu PENG, Jiangsu (CN); Wei ZHOU, Jiangsu (CN)

(73) Assignee: MOONLIGHT (NANJING) INSTRUMENT CO., LTD., Jiangsu (CN)

(21) Appl. No.: 17/583,239

(22) Filed: Jan. 25, 2022

Related U.S. Application Data
(63) Continuation-in-part of application No. PCT/CN2020/091353, filed on May 20, 2020.

(30) Foreign Application Priority Data
Jul. 31, 2019 (CN) 201910705942.2

(51) Int. Cl. G06V 10/80; G06T 5/10; G06T 5/50

(52) U.S. Cl. CPC G06V 10/806; G06V 10/803; G06T 2207/20221; G06T 5/50; G06T 5/10

(57) ABSTRACT

The present invention discloses an image fusion method based on Fourier spectrum extraction, which comprises: step 1, inputting a plurality of to-be-fused images to a processor of a computer by an input unit of the computer, and performing the following steps by the processor of the computer: performing Fourier transform on images at different focus positions, extracting a frequency component corresponding to an image with the maximum frequency amplitude in the images at different focus positions in a transformed frequency domain space, taking the frequency component as a frequency component of a fused image at the corresponding spatial frequency, traversing each frequency to generate a frequency domain component of the fused image, finally performing inverse Fourier transform on the frequency domain component of the fused image to obtain the fused image; and step 2, outputting the fused image obtained by the processor by an output unit of the computer.

### CROSS-REFERENCE TO RELATED APPLICATION

This is a continuation-in-part application of International Application No. PCT/CN2020/091353, filed on May 20, 2020, which claims the priority benefits of China Application No. 201910705942.2, filed on Jul. 31, 2019. The entirety of each of the above-mentioned patent applications is hereby incorporated by reference herein and made a part of this specification.

### TECHNICAL FIELD

The present invention relates to an image fusion method, in particular to an image fusion method based on Fourier transform spectrum extraction, and belongs to the technical field of image processing.

### BACKGROUND

As is an important field of information fusion, image fusion has been widely applied to the aspects of remote sensing, computer vision, medicine, military target detection and identification and the like.

At present, image fusion methods derived from multi-resolution are popular, a large category of which is based on Gaussian pyramid decomposition of images, and then Laplacian pyramid, gray pyramid, gradient pyramid and the like are derived; and another large category of which is an algorithm based on wavelet decomposition, the basic idea is to decompose the image into a series of sub-images at different resolutions, where each resolution comprises a blurred sub-image containing low frequency information and three sub-images with high frequency detail in a row, column, diagonal direction. The two methods have the common feature that images are fused according to a certain rule at different resolutions to obtain a fused image sequence.

### SUMMARY

In order to solve the technical problem, the present invention provides an image fusion method based on Fourier spectrum extraction, which extracts a clear image area through Fourier transform, thereby realizing a method for generating a picture containing detailed information of objects at different depths in the shooting direction by fusing a plurality of images under the shooting condition of small depth of field.

In order to solve the aforementioned technical problems, the present invention adopts the following technical scheme:

the present invention provides an image fusion method based on Fourier spectrum extraction, which comprises:

step 1, inputting a plurality of to-be-fused images to a processor of a computer by an input unit of the computer, and performing the following steps by the processor of the computer: performing Fourier transform on images at different focus positions, extracting a frequency component corresponding to an image with the maximum frequency amplitude in the images at different focus positions in a transformed frequency domain space, taking the frequency component as a frequency component of a fused image at the corresponding spatial frequency, traversing each frequency to generate a frequency domain component of the fused image, finally performing inverse Fourier transform on the frequency domain component of the fused image to obtain the fused image; and

step 2, outputting the fused image obtained by the processor by an output unit of the computer.

In the image fusion method based on Fourier spectrum extraction, performing the steps by the processor specifically comprises:

(1) obtaining gray image information of each image from the plurality of to-be-fused images:

fₙ(x,y), (x<K,y<L), n=1, 2, . . . , N

wherein, (x, y) is the pixel coordinate of the gray image, K and L are the boundary values of the image in X and Y directions, respectively, and N is the total number of the images;

(2) transforming the N gray images in a spatial domain obtained in the step (1) into the N gray images in a frequency domain by using two-dimensional discrete Fourier transform to obtain the frequency component of each image:

$${F}_{n} ( {f}_{x} , {f}_{y} ) = {\sum }_{x = 0}^{K - 1} {\sum }_{y = 0}^{L - 1} {f}_{n} ( x , y ) exp [ - j 2 π ( x {f}_{x} / K + y {f}_{y} / L ) ]$$

wherein, (fₓ,f_{y}) is the coordinate of the spatial frequency, and represents the spatial frequency in X and Y directions, and |Fₙ(fₓ,f_{y})| is the frequency domain amplitude;

(3) extracting the frequency component corresponding to the image with the maximum frequency amplitude |Fₙ(fₓ,f_{y})| in the N images at the spatial frequency (fₓ,f_{y}) as a frequency component of the fused image at the spatial frequency according to the frequency domain amplitude |Fₙ(fₓ,f_{y})| obtained in the step (2), traversing each point (i.e., each spatial frequency (fₓ,f_{y})) in the frequency domain, and finally generating a frequency domain component of the N fused images by adopting the method:

Fₙ(fₓ,f_{y})→F(fₓ,f_{y}); and

(4) performing inverse transform on the fused frequency domain component obtained in the step (3) by using two-dimensional discrete inverse Fourier transform to obtain a gray image reconstructed in the spatial domain, i.e., an image of N images after fusion:

$$f ( x , y ) = {\sum }_{x = 0}^{K - 1} {\sum }_{y = 0}^{L - 1} F ( {f}_{x} , {f}_{y} ) exp [ - j 2 π ( x {f}_{x} / K + y {f}_{y} / L ) ]$$

f(x,y) is the gray image obtained after reconstruction.

In the step (1), the number of the plurality of images N is greater than or equal to 2.

In the step (1), the plurality of fused images have the same field of view and resolution.

In the step (1), the plurality of images have different focus depths for objects at different depth positions or the same object.

Beneficial Effects: the image fusion method disclosed by the present invention appreciates that frequency domain signals represent information such as edge, texture and the like of the image in the spatial domain through the Fourier transform on the images at different focus positions, extracts the detailed information at different positions, synthesizes pictures with the detailed information of objects at different positions by using pictures with the same resolution without replacing cameras and lens, and therefore provides a quick and convenient image fusion method for the application fields of computer vision detection and the like, and the method is simple in calculation, and the fused image contains more image details.

### BRIEF DESCRIPTION OF THE DRAWINGS

FIG. 1 is a diagram of a system structure corresponding to the image fusion method based on Fourier spectrum extraction according to the present invention;

FIG. 2 is a flowchart of the image fusion method based on Fourier spectrum extraction according to the present invention;

FIG. 3 are to-be-fused images in the same field of view with the same camera shooting different focal planes in the present invention;

FIG. 4 are images of spatial frequency domain distribution after the two-dimensional discrete Fourier transform corresponding to the three images in FIG. 3;

FIG. 5 is a frequency domain image obtained by fusing the three images of spatial frequency domain distribution in FIG. 4; and

FIG. 6 is an image in the spatial domain reconstructed by two-dimensional discrete inverse Fourier transform on the frequency domain image in FIG. 5.

### DETAILED DESCRIPTION OF THE EMBODIMENTS

The present invention will be better understood from the following embodiments. However, it is easily understood by those skilled in the art that the descriptions of the embodiments are only for illustrating the present invention and should not and will not limit the present invention as detailed in the claims.

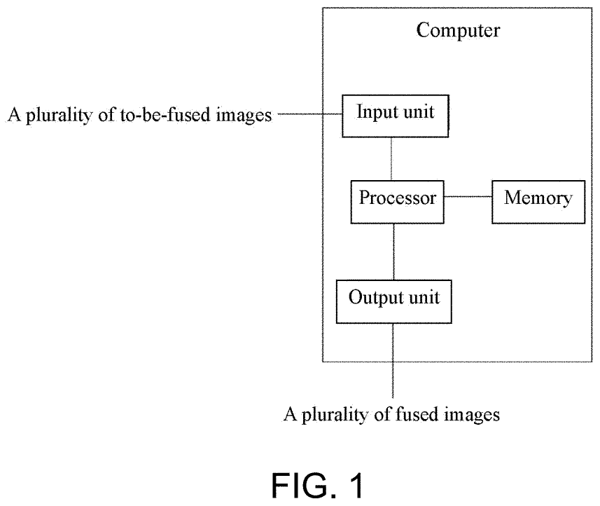

As shown in FIG. 1, the image fusion method based on Fourier spectrum extraction of the present invention comprises:

step 1, inputting a plurality of to-be-fused images to a processor of a computer by an input unit of the computer, and performing the following steps by the processor of the computer: performing Fourier transform on images at different focus positions, extracting a frequency component corresponding to an image with the maximum frequency amplitude in the images at different focus positions in a transformed frequency domain space, taking the frequency component as a frequency component of a fused image at the corresponding spatial frequency, traversing each frequency to generate a frequency domain component of the fused image, finally performing inverse Fourier transform on the frequency domain component of the fused image to obtain the fused image; and

step 2, outputting the fused image obtained by the processor by an output unit of the computer.

The input unit and the output unit are an input interface and an output interface of the processor, respectively, and the input interface and the output interface can be a network communication interface, a USB serial port communication interface, a hard disk interface and the like.

The image fusion method of the present invention extracts a clear image area based on Fourier transform, thereby generating a picture containing detailed information of objects at different depths in the shooting direction by fusing a plurality of images under the shooting condition of small depth of field. The algorithm of the present invention requires to shoot N images in different depth directions (Z direction) within the same field of view by changing focus positions of lens. Because of the limitation of the depth of field of the lens, each image can be clearly focused on the image plane (X, Y direction) only at a small depth in front and back near the focus plane. In order to display three-dimensional (X, Y, Z direction) information of a photographed object (or space) on one picture, N images are fused to generate one image. Detailed information (X, Y direction) of objects at different depth positions can be obtained from the image.

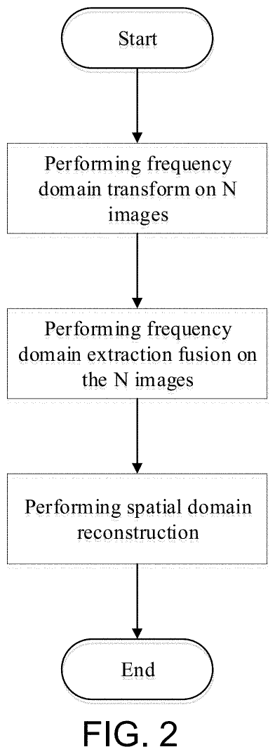

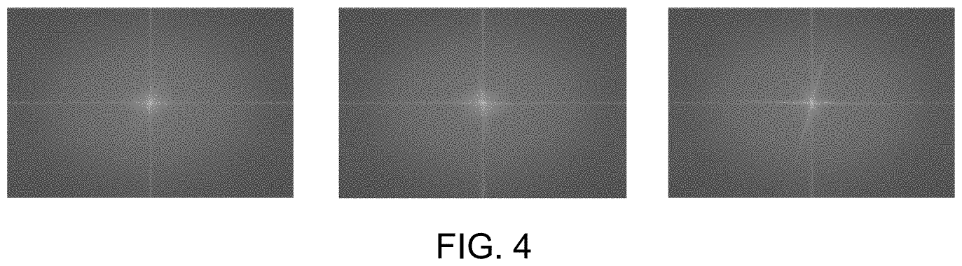

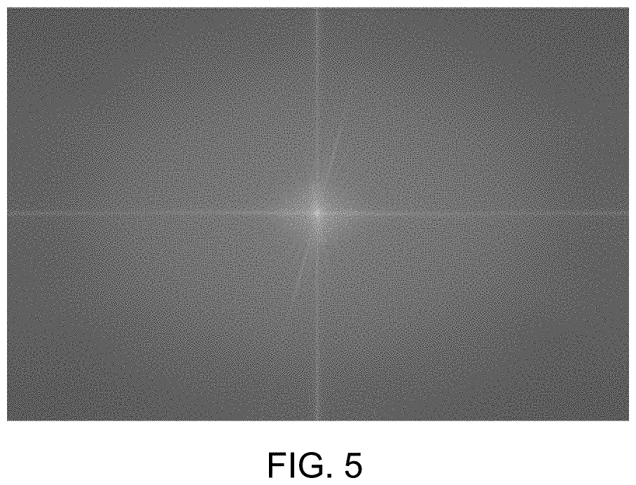

As shown in FIGS. 2-6, in the image fusion method based on Fourier spectrum extraction of the present invention, performing the steps by the processor specifically comprises:

(1) obtaining gray image information of each image from the plurality of to-be-fused images:

fₙ(x,y),(x<K,y<L), n=1, 2, . . . , N

wherein, (x,y) is the pixel coordinate of the gray image, and K and L are the boundary values of the image in X and Y directions, respectively; N is the total number of the images, and N is greater than or equal to 2; the plurality of images have the same field of view and resolution; the plurality of images have different focus depths for objects at different depth positions or the same object;

(2) transforming the N gray images in a spatial domain obtained in the step (1) into the N gray images in a frequency domain by using two-dimensional discrete Fourier transform to obtain the frequency component of each image:

$${F}_{n} ( {f}_{x} , {f}_{y} ) = {\sum }_{x = 0}^{K - 1} {\sum }_{y = 0}^{L - 1} {f}_{n} ( x , y ) exp [ - j 2 π ( x {f}_{x} / K + y {f}_{y} / L ) ]$$

wherein, (fₓ,f_{y}) is the coordinate of the spatial frequency, and represents the spatial frequency in X and Y directions, |Fₙ(fₓ,f_{y})| is the frequency domain amplitude, and the larger the amplitude is, the richer the frequency component is, and the more the detailed information of the image is;

(3) extracting the frequency component corresponding to the image with the maximum frequency amplitude |Fₙ(fₓ,f_{y})| in the N images at the spatial frequency (fₓ,f_{y}) as a frequency component of the fused image at the spatial frequency according to the frequency domain amplitude |Fₙ(fₓ,f_{y})| obtained in the step (2), traversing each point (i.e., each spatial frequency (fₓ,f_{y})) in the frequency domain, and finally generating a frequency domain component of the N fused images by adopting the method:

Fₙ(fₓ,f_{y})→F(fₓ,f_{y})

(4) performing the spatial domain image reconstruction step, wherein F(fₓ,f_{y}) comprises the detailed information of the images at different positions in the N images because of the directionality of fₓ,f_{y}, in order to obtain the fused image effect from the frequency domain to the spatial domain, performing inverse transform on the fused frequency domain component obtained in the step (3) by using two-dimensional discrete inverse Fourier transform to obtain a gray image reconstructed in the spatial domain, i.e., an image of the N fused images:

$$f ( x , y ) = {\sum }_{x = 0}^{K - 1} {\sum }_{y = 0}^{L - 1} F ( {f}_{x} , {f}_{y} ) exp [ - j 2 π ( x {f}_{x} / K + y {f}_{y} / L ) ]$$

f(x,y) is the gray image obtained after reconstruction.

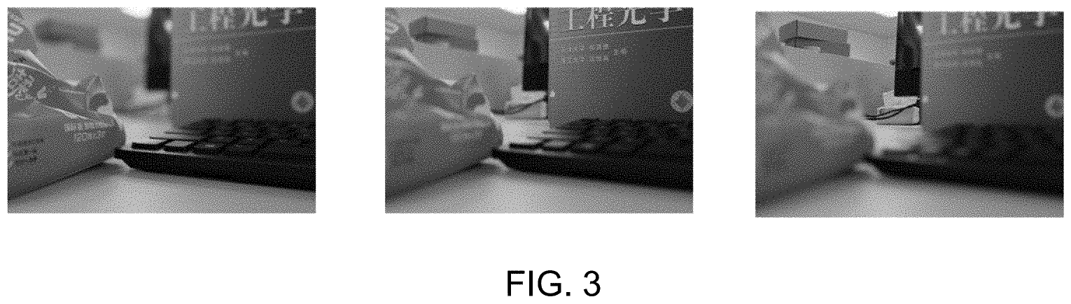

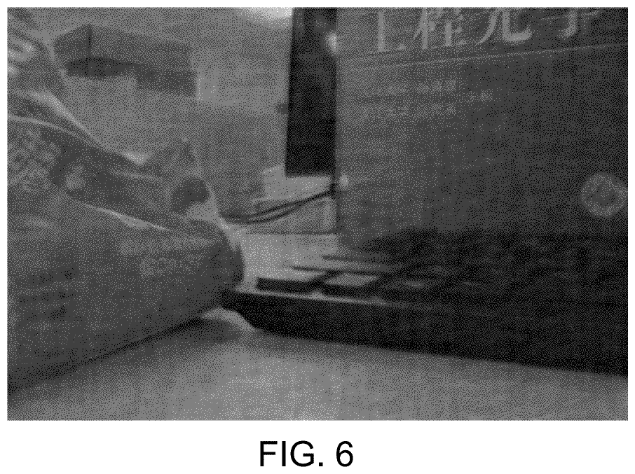

In FIG. 3, the images in the pictures are clearly displayed only at focus positions, that is, the edge and detailed texture information is richer; in the fused image (FIG. 6), the detailed information of the three focus positions is well fused into one image, that is, the detailed information of the objects at different shooting depth positions can be seen from one picture, so that the image fusion effect is effectively realized.

What is claimed is:

1. An image fusion method based on a Fourier spectrum extraction, comprising:
step 1, inputting a plurality of to-be-fused images to a processor of a computer by an input unit of the computer, and performing the following steps by the processor of the computer: performing a Fourier transform on images at different focus positions, extracting a frequency component corresponding to an image with a maximum frequency amplitude in the images at the different focus positions in a transformed frequency domain space, taking the frequency component as a frequency component of a fused image at a corresponding spatial frequency, traversing each of a frequency to generate a frequency domain component of the fused image, finally performing an inverse Fourier transform on the frequency domain component of the fused image to obtain the fused image; and
step 2, outputting the fused image, which is obtained by the processor by an output unit of the computer.

2. The image fusion method based on the Fourier spectrum extraction according to claim 1, wherein performing the steps by the processor specifically comprises:
(1) obtaining a gray image information of each of the image from the plurality of to-be-fused images:
fₙ(x,y), (x<K,y<L), n=1, 2, . . . , N
wherein, (x,y) is a pixel coordinate of a gray image, K and L are boundary values of the image in X and Y directions, respectively, and N is a total number of the images;
(2) transforming N gray images in a spatial domain, which is obtained in the step (1) into the N gray images in a frequency domain by using a two-dimensional discrete Fourier transform to obtain the frequency component of each of the image:
$${F}_{n} ( {f}_{x} , {f}_{y} ) = {\sum }_{x = 0}^{K - 1} {\sum }_{y = 0}^{L - 1} {f}_{n} ( x , y ) exp [ - j 2 π ( x {f}_{x} / K + y {f}_{y} / L ) ] ,$$
wherein, (fₓ,f_{y}) is the coordinate of a spatial frequency, and represents the spatial frequency in the X and Y directions, and |Fₙ(fₓ,f_{y}) is a frequency domain amplitude;
(3) extracting the frequency component corresponding to the image with the maximum frequency amplitude |Fₙ(fₓ,f_{y})| in N images at the spatial frequency (fₓ,f_{y}) as the frequency component of the fused image at the spatial frequency according to the frequency domain amplitude |Fₙ(fₓ,f_{y})| obtained in the step (2), traversing each of points in the frequency domain, and finally generating the frequency domain component of N fused images by adopting the method:
Fₙ(fₓ,f_{y})→F(fₓ,f_{y}); and
(4) performing an inverse transform on a fused frequency domain component obtained in the step (3) by using a two-dimensional discrete inverse Fourier transform to obtain the gray image, which is reconstructed in the spatial domain, i.e., an image of the N images after fusion:
$$f ( x , y ) = {\sum }_{x = 0}^{K - 1} {\sum }_{y = 0}^{L - 1} F ( {f}_{x} , {f}_{y} ) exp [ - j 2 π ( x {f}_{x} / K + y {f}_{y} / L ) ] ,$$
f(x,y) is the gray image, which is obtained after reconstruction.

3. The image fusion method based on the Fourier spectrum extraction according to claim 2, wherein: in the step (1), a number of a plurality of the images N is greater than or equal to 2.

4. The image fusion method based on the Fourier spectrum extraction according to claim 2, wherein: in the step (1), a plurality of fused images have a same field of view and resolution.

5. The image fusion method based on the Fourier spectrum extraction according to claim 2, wherein: in the step (1), the plurality of images have different focus depths for objects at different depth positions or a same object.
